(19) United States
(12) Patent Application Publication
(10) Pub. No.: US 2015/0074905 A1
(43) Pub. Date: Mar. 19, 2015

(54) MEANS OF TRANSPORT WITH BATTERY DRIVEN COOLING OF A SLEEPING DRIVER

(71) Applicant: Climazleeper Holder APS, Odense (DK)

(72) Inventor: Torsten Nordentoft, Speracedes (FR)

(73) Assignee: Climazleeper Holding Aps, Odense (DK)

(21) Appl. No.: 14/394,932

(22) PCT Filed: Apr. 15, 2013
(86) PCT No.: PCT/EP2013/057797

§ 371 Date: Oct. 16, 2014

Related U.S. Application Data
(60) Provisional application No. 61/625,288, filed on Apr. 17, 2012.

(51) Int. Cl. A47C 21/04; B60H 1/00; A47G 9/00

(52) U.S. Cl. CPC A47C 21/04; A47G 9/00; B60H 1/00
USPC 5/423

(57) ABSTRACT

A means of transport comprising an energy storage and an assembly of an air pump, an air conditioning device, a duvet and a mattress, wherein the air pump and the air conditioning device are powered by the energy storage, and the air pump is adapted to pump air conditioned by the conditioning device into an air receiving compartment of the duvet and/or mattress, the air receiving compartment being adapted to output received air toward a space between the duvet and the mattress. In this manner, not all of the compartment, such as a drivers compartment or a sleeping compartment needs be cooled.

The present invention relates to a vehicle wherein a driver may be cooled or heated while sleeping and in particular to a type of bed where the cooling/heating is focused on the driver and not the compartment.

Products of this type may be seen in e.g. www.sleepdeep.se, where air is sucked via the mattress from the body of the user and out of the bed, so that air from the surroundings is forced through the bed cover and to the person so as to cool the person.

Other solutions may be seen in: GB889865, U.S. Pat. No. 7,945,979, U.S. Pat. No. 6,446,290, U.S. Pat. No. 6,581,225, U.S. Pat. No. 4,665,575, EPO493267, U.S. Pat. No. 3,529,310, WO11091788, CA2623097, US2009271923, WO11093762, US2009276958, FR2754156, U.S. Pat. No. 5,165,127, US6085369, US6263530, EP1951089, US2011035880, AU2008200388, U.S. Pat. No. 6,546,576, GB1386249, EP1762211, U.S. Pat. No. 7,913,332, DE20313150 U1, U.S. Pat. No. 5,730,120, WO08123640, US2003150060, GB1168251, U.S. Pat. No. 7,666,214, EP1804616, GB1311461, U.S. Pat. No. 7,165,281, EP0957727, U.S. Pat. No. 6,855,158, U.S. Pat. No. 5,392,847, EP0859564, EP1723877, GB2414178, U.S. Pat. No. 6,487,739, U.S. Pat. No. 6,687,937, U.S. Pat. No. 6,402,775, U.S. Pat. No. 6,764,502, U.S. Pat. No. 4,884,304, U.S. Pat. No. 5,033,136, U.S. Pat. No. 6,551,347, U.S. Pat. No. 7,001,417, U.S. Pat. No. 7,908,687, U.S. Pat. No. 7,631,377, U.S. Pat. No. 7,975,331, GB2446572, U.S. Pat. No. 3,101,488, US2011035879, U.S. Pat. No. 8,074,307, GB965133, GB724910, US2006101577, U.S. Pat. No. 8,065,763, U.S. Pat. No. 3,230,556, EP1947986, U.S. Pat. No. 6,269,504, U.S. Pat. No. 6,701,556, U.S. Pat. No. 7,191,480, U.S. Pat. No. 7,191,482, U.S. Pat. No. 7,480,953, U.S. Pat. No. 7,617,555, U.S. Pat. No. 7,966,680, DE6927743 U, U.S. Pat. No. 5,109,560, GB2333230, DE202010017223 U1, WO02062185, U.S. Pat. No. 4,959,877, U.S. Pat. No. 7,181,786, US2007169264, CA2541341, US2012017371, US2004031103, GB2456814, US2005086739, GB2398506, U.S. Pat. No. 3,266,064, U.S. Pat. No. 7,877,827, U.S. Pat. No. 7,996,936, US2011296611, U.S. Pat. No. 6,363,551, U.S. Pat. No. 7,240,386, U.S. Pat. No. 7,467,435, U.S. Pat. No. 7,650,658, U.S. Pat. No. 7,950,084, U.S. Pat. No. 7,272,936, U.S. Pat. No. 7,480,950, U.S. Pat. No. 7,937,789, U.S. Pat. No. 7,914,611, U.S. Pat. No. 8,118,920, EP1044637, WO12019236, U.S. Pat. No. 4,939,804, GB1321865, US2008263776, US2010043143, WO9510211, DE102009044308, EP0113149, US2012000207, US2011314837, US2011289684, US2011041246, US2008028536, U.S. Pat. No. 4,777,802, WO9633642, U.S. Pat. No. 6,336,237, DE10139484 B4, U.S. Pat. No. 6,730,115, U.S. Pat. No. 6,826,792, CN85100943, CN2090655, CN2239194, CA1272815, CN2068786, TWM392597, CN2571272, DE202005011452 U1, US2007033733, JP3186632 B2, JP7313306 A2, KR20020083648, CN2882417, and CN201139285.

In a first aspect, the invention relates to a means of transport comprising an energy storage and an assembly of an air pump, an air conditioning device, a duvet and a mattress, wherein the air pump and the air conditioning device are powered by the energy storage, and the air pump is adapted to pump air conditioned by the conditioning device into an air receiving compartment of the duvet and/or mattress, the air receiving compartment being adapted to output received air toward a space between the duvet and the mattress

In this respect, a means of transport typically is a lorry or truck but may in principle be any type of vehicle, boat, ship, bus, lorry, truck, car, or the like.

The means of transport comprises an energy storage. Many types of energy storage are known. The most widely used energy storage is a battery, and naturally, any type of battery may be used, but other types of storage may also be used, such as a flywheel.

Usually, the mattress/duvet will be provided in a dedicated sleeping/resting compartment in the means of transport, such as a sleeping cabin in a truck or a boat, but this is not a requirement, as only the space between the duvet and mattress is desired conditioned, so that the surroundings, such as where in the means of transport, the mattress/duvet are positioned, is less important.

The air pump may operate on any type of technology, and the air pump may receive air from the conditioning device or the surroundings of the assembly, or the vehicle, and may transport air to the mattress/duvet directly or via the conditioning device. Naturally, other elements, such as filters and sensors, may be provided between the pump, mattress/duvet, conditioning device, and the surroundings.

The mattress, if it comprises the compartment, may be a standard mattress on top of which is provided a conditioning element having the air receiving compartment, or the mattress itself may have the air receiving compartment.

The duvet may be a single-layer element, such as a blanket, or may be a multiple-layer element, such as a duvet with upper and lower layers between which an insulating material, such as cotton, non-woven fibres, feathers, down, or the like, is provided. If the duvet has the air receiving compartment, this compartment may be provided in, such as inside or combined therewith, the duvet or may be a separate conditioning element provided between the duvet and the mattress.

The user, such as a sleeping person, may then lie on the mattress and under the duvet, where the mattress or duvet has the air receiving compartment, or the person may lie on or under an element having the air receiving compartment. Under all circumstances, the air receiving compartment will act to output conditioned air toward the person.

Both the duvet and the mattress may receive the conditioned air, or only one of them may receive this air.

The air pump and the air conditioning device are powered, preferably solely, by the energy storage so as to not require the addition of mains power from an external power source, such as a quay, a house or the like. Naturally, the energy storage may be aided by solar panels or the like provided on the means of transport.

This powering by the energy storage has the advantage that the main engine of the means of transport may be cut of or shut down while the conditioning assembly is in operation, so that the driver/captain may sleep while the engine is off. Usually, this engine would be able to provide ample power for a conditioning unit, but if no propulsion of the means of transport is desired, the pollution and fuel consumption of the main engine is a waste which is to be avoided. Other solutions have been to provide smaller engines, also spending fuel, for such cooling/heating assemblies, but this is also undesirable as they also pollute.

With the present conditioning assembly, it has been found that a person may be cooled/heated for 8 hours using only 150-200 W. As a comparison, cooling a sleeping cabin of a truck in ambient temperatures of 40° C. requires about 2 kW, which would require so many truck batteries that this solution would be very impractical.

In one embodiment, the air conditioning device comprises a device for adapting a temperature of the air. In that or another embodiment, the air conditioning device comprises a dehumidifier for generating dehumidified air. Only in rare situations is it desired to add humidity to the air provided toward the human body during sleep.

Naturally, the temperature and humidity may be controlled on the basis of sensed values from the person's body, the space between the duvet and mattress or the air receiving compartment. The sensor(s) used may be any type of temperature/humidity sensor, based on any technology, such as optical sensing, thermometers, humidity sensors or the like, and the processor may be based on any technology, software controlled, hardwired, FPGA, ASIC, or any combination thereof.

In one embodiment, the duvet and/or mattress, the conditioning element or the air receiving compartment comprises a first and a second, generally oppositely positioned, layers and an opening for receiving the conditioned air, where the first layer is generally air impenetrable, and the second layer is an outer, air penetrable layer. In this manner, the received air will exit the duvet/mattress/compartment at least predominantly through the second outer layer. Then, the mattress/duvet/compartment has a conditioning side, which is preferably directed toward the space between the mattress and duvet.

The first layer may be an outer or an internal layer.

Then, if the mattress/duvet/element/compartment has a side or side portions, these are preferably also generally air impenetrable so as avoid “wasting” conditioned air via these surfaces.

In this respect, “generally air impenetrable” will mean that the penetrability of this side is much lower, such as at least 3 times lower, preferably at least 5 times lower, such as at least 10 times lower, than the penetrability of the second outer layer, so that the predominant part of the received, conditioned air will exit the second outer layer.

Naturally, the second outer layer may be adapted to output the received air evenly over its surface, or it may be adapted to output more air over some parts of its surface than other areas. This is explained further below.

In general, air penetrability of a layer or surface may be determined as the amount of air passing through the layer/surface per unit of time and with a predetermined pressure difference over the layer/surface.

The penetrability of a layer/surface may be adapted or controlled by controlling the pressure difference, the size and/or number of openings in the layer/surface through which the air passes, as well as the layer/surface thickness. The openings may be formed in a woven material between the strands of the fabric or the fibres/strands in a non-woven material, or the openings may be provided in a material, such as an otherwise air impenetrable material. Such openings may be provided by punching needles or other elements through the material or via e.g. laser ablation.

In one embodiment, the duvet or mattress has, across a width thereof, at least one outer portion having a first air penetrability and at least a second portion having a second penetrability, the second penetrability being at least 3 times, such as at least 5 times, preferably at least 10 times, the first penetrability.

In this respect, the mattress or duvet usually has a length direction directed along the length of a sleeping person. The width then usually is the dimension perpendicular to the length direction.

The outer portion may be at least the outermost 5%, such as at least the outermost 10% of the mattress/duvet—in one side or preferably at both sides thereof.

In this embodiment, it is realized that a sleeping person will tend to not use the outer-most parts of a mattress/duvet. In addition, the person will, if too hot, seek toward a cooled part or, if too cold, seek toward a heated part, so that the person will seek toward the conditioned part even during his/her sleep. In addition, when only conditioning a non-extreme part of the mattress/duvet, less conditioned air is “wasted” by not reaching the space where the person is intended to lie.

Above, one manner of providing a differentiated amount of conditioned air from a surface is described. Naturally, other methods are available, and as long as the overall objective of conditioning the space as desired is reached, the ways of obtaining this is of less importance.

Another manner is to have the air receiving compartment extend, along a width of the mattress or duvet, no more than 85% of the width of the mattress or duvet, such as no more than 75% of the width. In this manner, the air exiting the compartment may also be provided into the space from this part of the width of the mattress/duvet. This embodiment may be combined with any of the other embodiments, so that the compartment may have an air impenetrable side etc.

Yet another manner, which has additional advantages, is one wherein the wherein the duvet or mattress has, across a width thereof, at least one outer portion and at least a second portion having a predetermined width, the second portion comprising an air penetrable layer having a width exceeding the predetermined width.

Again, the outer portion may be the outermost at least 5%, such as at least the outermost 10, 15, 20% of the mattress/duvet.

In this embodiment, the second portion has a layer which is actually wider than the second portion in itself. Thus, this layer is able to, when a pressure difference exists over the layer due to the providing of conditioned air in/from the compartment, be “inflated” or forced outwards and thus obtain a convex shape extending away from a body of the mattress/duvet and/or into the space between the mattress and the duvet.

This convex shape has the advantage that it may adapt better to the shape of a sleeping person in the space between the mattress and duvet, so that the penetrable layer actually “inflates” and conforms to parts of the body of the sleeping person and thus provides conditioned air directly to the person. In addition, the layer will conform to the person also when the person moves, so that it may be depressed at some areas due to the person's weight and at other areas may be inflated to contact the person also at positions where the person does not force the layer toward the mattress/duvet or does not support him/herself on the mattress or where the duvet supports itself on the person.

Naturally, the air penetrability of this layer may differ along the length or across the width thereof, and one or more such second portions may be provided.

It may be desired that less conditioned air is provided to the feet of the person than at the chest, and it may be desired to also have air provided at the head of the person, even though this air is fed into the surroundings and not to the space under the duvet.

It may be decided that at a line along a longitudinal direction of the mattress/duvet and at the center, in the width direction, the person will support his weight on the mattress or the duvet will support on his/her body, whereby air outlet openings may be fully or partly blocked by the person, so that the amount of air which may exit the mattress/duvet/compartment at this central portion may be small. Thus, it may be decided to, instead, provide two elongated, air penetrable longitudinally directed portions which are not provided at the center, in the width direction, but between the center and the outermost portions. More than two such second portions may be used if desired. Thus, apart from the 5, 10, or 15% of the width in both sides being the outermost parts, a central portion of 10, 20, 30 or 40% may be air impenetrable, if desired.

A second aspect of the invention relates to a mattress or duvet for use in the means of transport according to the first aspect. This duvet/mattress has the air receiving compartment and/or separate conditioning element and may have any of the above features.

A third aspect of the invention relates to a method of conditioning a space between a mattress and a duvet in a means of transport further comprising an energy storage and an assembly of an air pump, and an air conditioning device, the method comprising powering the air pump and the air conditioning device by the energy storage, the air pump pumping air conditioned by the conditioning device into an air receiving compartment of the duvet or mattress and from the duvet or mattress into the space.

All the above considerations are equally valid for this aspect of the invention.

Thus, the powering of the air pump and the air conditioning device is, preferably solely, carried out by the energy storage. Again, this is to avoid having to use any engines for providing power or any outside power sources, such as a house, a service facility or a quay.

The air pump pumps air conditioned by the conditioning device into the air receiving compartment of the duvet or mattress and from the duvet or mattress into the space. The order of the pump and the conditioning device is irrelevant, as is the source of the air. Further elements may be provided in the air flow, such as sensors, filters or the like.

The means of transport usually will have one or more engines adapted to provide power to the energy storage when operating. Usually, such engines will be turned off, when the air pump and the conditioning device are operable.

In one embodiment, the air conditioning device adapts a temperature of the air and in that or another embodiment, the air conditioning device adapts a humidity of the air. Usually, this adaptation is a reduction of the humidity, as a person is more easily capable of cooling, when the air surrounding her/him has a lower humidity.

In one embodiment, the duvet and/or mattress comprises a first and a second, generally oppositely positioned, layers and wherein, when conditioned air is provided to the space, substantially no air exits the mattress or duvet through the first layer.

As mentioned above, the air exiting the mattress through the first layer—or side portions of the mattress/duvet—may be considered lost and thus adds to the power consumption without doing any good.

Again, the air penetrability of the second layer, which preferably is an outer layer, may be even or varying over the second layer.

In one embodiment, the duvet or mattress has, across a width thereof and on one side thereof, at least one outer portion and at least a second portion, wherein at least 70%, such as at least 80%, preferably at least 90% of the air exiting the mattress or duvet exits the mattress or duvet through the second portion. This portion preferably takes up less than 60%, such as less than 50% of an area of a side of the duvet or mattress.

The above considerations of the outer portions, the manners of providing different air flow or air penetrability to the surface or different parts of the surface are equally valid in this regard.

One embodiment further comprises the step of the air compartment “expanding” or being forced away from a body of the mattress/duvet to form a convex outer surface of the duvet or mattress, such as extending into or toward the space between the mattress and the duvet.

As mentioned above, this convex outer surface may then adapt better to the shape of the person, even though the person may depress or compress the shape at positions where he/she supports him/herself on the mattress or the duvet supports itself on the person.

Also, multiple second surfaces may be provided, “expanding” or not. These are usually provided in the longitudinal direction of the duvet/mattress, but may also have different air penetrability along the length thereof if desired.

In the following, preferred embodiments of the invention are described with reference to the drawing, wherein:

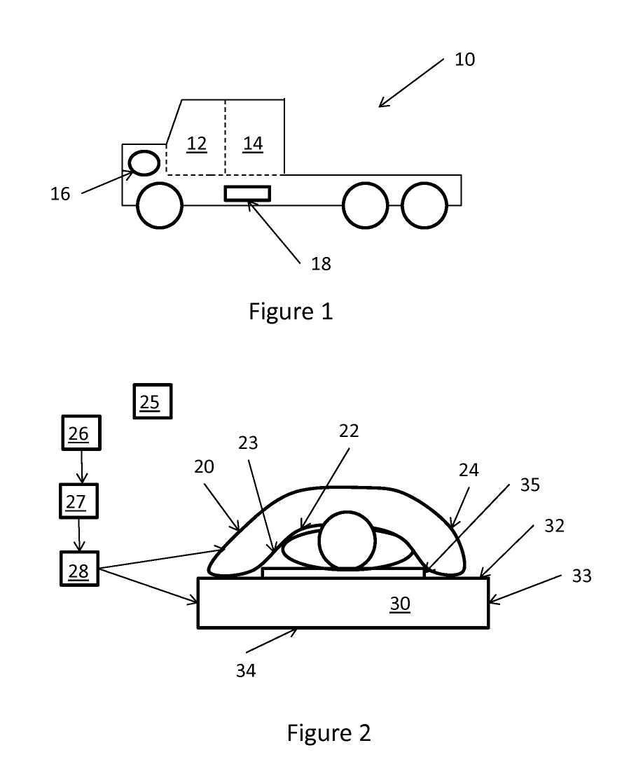

FIG. 1 illustrates a vehicle with a sleeping compartment,

FIG. 2 illustrates a sleeping person on a mattress and with a duvet.

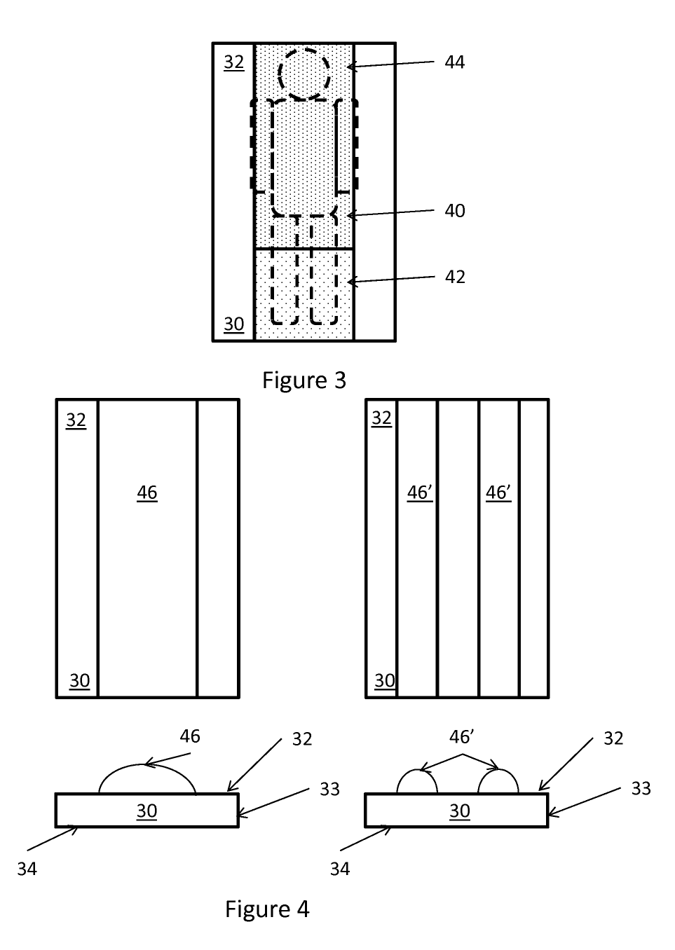

FIG. 3 illustrates a sleeping person on a first embodiment of a mattress

FIG. 4 illustrates two different embodiments of a mattress and

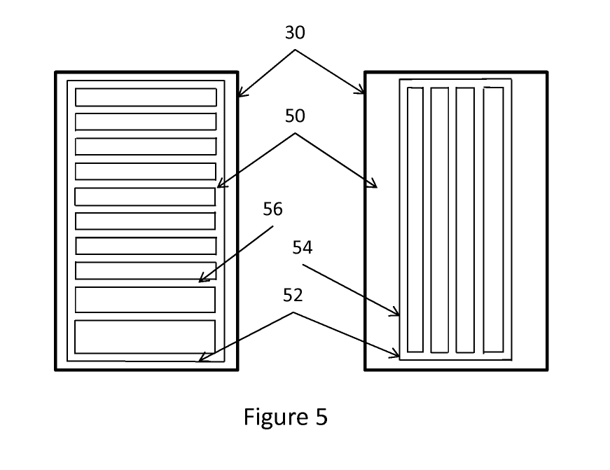

FIG. 5 illustrates different manners of distributing air inside mattresses.

In FIG. 1, a vehicle 10, here in the shape of a tractor 10, also called a road tractor or traction head, for pulling a semi-trailer. This tractor 10 has an engine 16 and a battery 18, a driver's cabin 12 and a sleeping cabin 14. The driver's cabin 12 and the sleeping cabin 14 may be separated or be the same compartment.

During operation of the tractor 10, the driver of course will be in the driver's cabin 10, but when resting or sleeping, the driver may retreat to the sleeping cabin 14, where a bed may be installed.

In FIG. 2, the bed may be seen with the driver in it. The bed has a mattress 30 having an upper side 32 on which the driver rests, and a lower side 34. The driver is covered, to a certain degree, by a duvet or cover 20 which has an upper side 24 and a lower side 22 facing the driver.

The following description relates to the cooling of a driver in a hot cabin 14, such as when parked during the day in Africa. Naturally, a similar heating may be provided if desired. The driver will have to sleep and watch the local rules on driving and resting for long-haul drivers. Thus, in order to utilize his time optimally, the driver may have to sleep during the day. In this manner, the vehicle will be parked during the day, in the sun, without the engine operating. In another embodiment, the vehicle 10 may be parked during the night above the Arctic Circle also with the engine stalled but now requiring heating of the driver. In this respect, only the power stored in the battery 18 is available for this cooling/heating. Therefore, an efficient and focussed cooling/heating is required.

An air pump 28 is provided which forces air from a de-humidifier 26 and a tempering device 27 into the duvet 20 and/or the mattress 30 so as to cool the sleeping driver. Naturally, the order of the pump 28, tempering device 27 and de-humidifier 26 may be altered if desired.

A processor 25 is provided for controlling operation of the pump 28, the de-humidifier 26 and the tempering device 27 on the basis of signals received from one or more sensors 23 provided at the lower surface 22 or the upper surface 32, and/or inside the duvet 20 or mattress 30, if desired, for providing information relating to the temperature and/or humidity at the sleeping person's body.

When the air is pumped into the duvet 20, it is desired that the air is fed toward the driver's body in order to cool the driver while using the lowest possible amount of power. Then, the upper layer 24 of the duvet 20 is air impenetrable or at least much less penetrable than the lower layer 22 which acts to feed the received, cooled, dehumidified air toward the body of the driver.

When the air is pumped into the mattress 30, the lower layer 34, and preferably also side portions 33 of the mattress 30 are air impenetrable or at least much less penetrable than the upper layer 32 which acts to feed the received, cooled, dehumidified air toward the body of the driver. The lower layer 34, the upper layer 24 and side portions 33 may be provided as a plastic, polymer, rubber material or the like. Alternatively, a fabric may be used which has no or a very low air penetrability.

Naturally, the pump 28 may feed air to both the mattress 30 and the duvet 20 if desired.

The lower surface 22 and/or the upper surface 32 may be provided in a number of manners in order to ensure or facilitate air passage thereof. One manner is to provide the surface, or part thereof, as a gas penetrable weave or non-woven. Alternatively, the surface may be provided with openings or holes, such as by penetration of needles, laser ablation or the like.

An alternative to the embodiment of FIG. 2 is one wherein a standard duvet 20 may be used below which is provided a relatively thin cooling/conditioning element having an air impenetrable upper side/surface and an air penetrable lower surface. Thus, the standard duvet 20 may provide the usual sleeping comfort and thermal insulation toward the surroundings, and the cooling/conditioning element may then perform the air transport toward the sleeping person.

An alternative to this would be to use a standard mattress 30 on top of which is provided a cooling/conditioning element 35 with an air impenetrable lower surface and an air penetrable upper surface guiding air toward the sleeping person. The mattress 30 then handles the sleeping/lying comfort while the cooling/conditioning element handles the cooling. Then, any type of mattress 30, such as foam mattresses, air mattresses, or spring mattresses may be used.

These cooling/conditioning elements may have all features mentioned above and below for the mattress/duvet.

Naturally, when the mattress 20 is provided with the tempered air, the full surface 32 may be air penetrable. It may, however, be desired to provide only a part of the upper surface 32 with the air penetrable properties and even vary these over the penetrable area, in order to reduce the energy consumption while providing a comfortable environment for the person.

Even though the below embodiments are described for the mattress, the same considerations are equally valid for use in the duvet.

The mattress or duvet—or the conditioning element—thus may form an air receiving compartment delimited by the outer surfaces of the mattress/element/duvet. Naturally, this compartment may be further delimited within the mattress/duvet/element if desired, such as when air is not desired output from a part of a mattress, the compartment may be delimited to not reach that part of the mattress. In the below examples where only part of a surface is to output air, the compartment may be delimited by that surface and inner elements of the mattress, so that the other outer surfaces of the mattress do not form part of the compartment and thus may have any air penetrability, as the air impenetrability is now taken care of by these inner elements.

In FIG. 3, only a central part of the upper surface 32 is air penetrable. The outer portions of the surface 32 may be air impenetrable. Two zones are illustrated below the sleeping person: a zone 40 with higher air penetrability and a zone 42 with a lower penetrability. Higher and lower penetrability may be obtained using different fabrics, more or fewer threads per mm in a woven material, larger or smaller thickness, more or fewer—and/or larger or smaller—holes in a material, or the like. Alternatively, the amount or the pressure of air fed to the different zones may be different, so that the same material may be used.

Thus, in this embodiment, different amounts of air may be provided to the feet compared to the remainder of the body of the person. A zone 44 is indicated at the head of the person, as it may be desired to provide an even larger air flow/cooling at the person's head, as this usually will be uncovered and thus exposed to the hot/cold environment compared to the body covered by the duvet 20.

Additionally or alternatively, a central portion of the surface 32 may be less air penetrable, as may the outermost parts, but parts there between, as illustrated by the areas 46′ in the right part of FIG. 4, may be air penetrable.

FIG. 4 illustrates other manners of providing not only cooling areas of the upper surface 32 but where these parts of the mattress 30, duvet 20 or cooling element are adapted to adapt more than standard, flat mattresses to the shape of the sleeping person, such as when forming a deformable, convex surface of the mattress or duvet. This shape may be brought about either by filling the part 36 with a deformable filling material or by adjusting the air pressure therein and allowing this part 36 to take up the convex shape (such as when being stretchable or being formed by a piece of cloth allowing this shape) when the air pressure is sufficient.

Then, when the sleeping person lies in the bed, he/she will depress the part 46 where he/she lies, but the remainder of the part 46 will obtain a convex shape and therefore conform more to the person's body. At the same time, these convex parts will not be blocked by the person's body, so that these parts now conforming better to the shape of the body also act to provide tempered air to a larger portion of the person's body.

FIG. 4 illustrates two manners of obtaining the advantages of this convex shape. In the left illustration, the central portion 46 may be inflated to form a single, elongated, convex part, and in the right illustration, two parts 46′ are provided. The right illustration may be as efficient as the left illustration, as the user will, when lying down, primarily depress the central portion of the portion 46 and thereby more or less block air passage there through.

FIG. 5 relates to manners of distributing the air inside the mattress 30 or the duvet 20. Especially in the mattress 30, there is a danger of the person accidentally blocking an air input during his/her sleep and thereby cutting of the flow of tempered air. Also, distributing air inside a mattress partially compressed under the weight of the person may be a challenge, depending on the build, structure and technology of the mattress 30.

Some mattresses are spring mattresses through which air may easily be distributed, as the springs take up relatively little space inside the mattress even during use.

Other mattresses are foam mattresses, through which air transport may be difficult even when not in use.

Air distribution inside duvets is less of a problem, as these are not compressed under the weight of a person.

However, if the air pressure is low, or if the duvet—or the above cooling/conditioning elements for use with a duvet or mattress—is/are desired thin, air guides may also be desired.

Two manners of distributing air inside e.g. a foam mattress 30 are illustrated in FIG. 5, wherein an outer air distributing channel, with channels 50 directed along the length and channels 52 along the width, is provided which feeds channels extending below the surface 32 or the smaller portions 40, 42, 44, 46 or 46′. In the right illustration, the channels 54 are directed along the length of the mattress. This embodiment has the disadvantage, that the person may block a large part of the channels 54 and thereby have a reduced cooling/heating, whereas the left illustration has more channels 56 and therefore a better cooling/heating no matter in what position the user sleeps.

In addition, FIG. 5 illustrates two different widths of the air providing channels. Naturally, if air is only desired output at in the areas 40, 42, 44, 46 and/or 46′, air need not be provided to the outer parts of the mattress 30 or duvet 20.

Thus, a mattress or a duvet may have therein a compartment receiving the air and forwarding the air toward the person, or an element may be provided between the mattress or duvet and the person may lie on or under this element, where the element has an air penetrable surface facing the person and emitting conditioned air toward the person.

It is noted that additional sensors may be provided inside the surroundings, the air pump, the conditioning devices or the flow path from the surroundings and through the pump, conditioning devices and to the duvet/mattress/element in order to control the operation of the pump and conditioning devices. Also, different sensors may be provided on or at the person in order to determine the conditions at that position and again control the operation of the assembly.

Naturally, the actual manner of operation of the pump and conditioning devices as well as the processor are not critical. Multiple different types of pumps, conditioning devices, mattresses, duvets, air penetrable and air impenetrable surfaces etc. are known to the skilled person, and the skilled person will have no problems in setting up the present invention in any means of transport and in any environment. Usually, cooling of the person is desired, but if heating is of essence, this is merely a small change of the assembly.

It is noted that the present invention may also be used outside means of transport, such as for heating/cooling persons in extreme environments, such as desserts, using only a minimal amount of energy.

1. A means of transport comprising an energy storage and an assembly of an air pump, an air conditioning device, a duvet and a mattress, wherein the air pump and the air conditioning device are powered by the energy storage, and the air pump is adapted to pump air conditioned by the conditioning device into an air receiving compartment of the duvet and/or mattress, the air receiving compartment being adapted to output received air toward a space between the duvet and the mattress.

2. A means of transport according to claim 1, wherein the air conditioning device comprises a device for adapting a temperature of the air.

3. A means of transport according to claim 1, wherein the air conditioning device comprises a dehumidifier for generating dehumidified air.

4. A means of transport according to claim 1, wherein the duvet and/or mattress comprises a first and a second, generally oppositely positioned, layers and an opening for receiving the conditioned air, where the first layer is generally air impenetrable, and the second outer layer is an outer, air penetrable layer.

5. A means of transport according to claim 1, wherein the duvet or mattress has, across a width thereof, at least one outer portion having a first air penetrability and at least a second portion having a second penetrability, the second penetrability being at least 3 times the first penetrability.

6. A means of transport according to claim 1, wherein the air receiving compartment extends, along a width of the mattress or duvet, no more than 75% of the width of the mattress or duvet.

7. A means of transport according to claim 1, wherein the wherein the duvet or mattress has, across a width thereof, at least one outer portion and at least a second portion having a predetermined width, the second portion comprising an air penetrable layer having a width exceeding the predetermined width.

8. A mattress or duvet for use in the means of transport according to claim 1.

9. A method of conditioning a space between a mattress and a duvet in a means of transport further comprising an energy storage and an assembly of an air pump, and an air conditioning device,
the method comprising powering the air pump and the air conditioning device by the energy storage, the air pump pumping air conditioned by the conditioning device into an air receiving compartment of the duvet or mattress and from the duvet or mattress into the space.

10. A method according to claim 9, wherein the air conditioning device adapts a temperature of the air.

11. A method according to claim 9, wherein the air conditioning device adapts a humidity of the air.

12. A method according to claim 9, wherein the duvet and/or mattress comprises a first and a second, generally oppositely positioned, layers and wherein, when conditioned air is provided to the space, substantially no air exits the mattress or duvet through the first layer.

13. A method according to claim 9, wherein the duvet or mattress has, across a width thereof, at least one outer portion and at least a second portion, wherein at least 70% of the air exiting the mattress or duvet exits the mattress or duvet through the second portion.

14. A method according to claim 9, further comprising the step of the air compartment expanding to form a convex outer surface of the duvet or mattress.
